(19) United States
(12) Patent Application Publication
(10) Pub. No.: US 2016/0063523 A1
(43) Pub. Date: Mar. 3, 2016

(54) FEEDBACK INSTRUMENT MANAGEMENT SYSTEMS AND METHODS

(71) Applicants: Diana Ioana Nistor, Aliso Viejo, CA (US); Kim Nga Thi Moore, Irvine, CA (US)

(72) Inventors: Diana Ioana Nistor, Aliso Viejo, CA (US); Kim Nga Thi Moore, Irvine, CA (US)

(21) Appl. No.: 13/683,115

(22) Filed: Nov. 21, 2012

(51) Int. Cl. G06Q 30/02

(52) U.S. Cl. CPC G06Q 30/0203

(57) ABSTRACT

A feedback instrument management system may be used to send a feedback instrument based on a user interaction. The user interaction and one or more feedback instruments may be received at a processing module. The feedback instruments may each have an associated set of rules and limiting criteria. The processing module may determine which feedback instruments have all rules satisfied and have not met the limiting criteria. A feedback instrument from the set of feedback instruments that have all rules satisfied and have not met the limiting criteria may be selected. The selection may be based on a priority value or an auction. The auction may be based on auction factors, such as satisfaction scores. The selected feedback instrument may be sent to the user.

### BACKGROUND

Surveys or other feedback instruments may be used to receive feedback on a given topic. In some instances, the survey questions and surveys may be manually and specifically created for a specific topic on which to receive feedback. To address a different specific topic, a new specific survey may be manually created. In other instances, the survey questions and the surveys may broadly address a broad topic.

### SUMMARY

One implementation relates to a computer-implemented method for sending a feedback instrument to a user. The method may include receiving multiple feedback instruments and data indicative of a user interaction associated with a service or product. Each feedback instrument may include one or more rules and a limiting criterion. A determination may be made whether the rules of each feedback instrument are satisfied based, at least in part, on the user interaction. An indication may be made that the user is a candidate for a feedback instrument if the one or more rules are satisfied. A determination may be made whether the limiting criterion for each feedback instrument has not been met for each feedback instrument for which the user is a candidate. A selection of a feedback instrument may be made from a set of one or more feedback instruments both that the user is indicated a candidate and that the limiting criterion has not been met. The selected feedback instrument may then be provided to the user.

In another implementation, a system for managing feedback instruments may include one or more data processors and one or more computer readable storage devices storing instructions. The instructions may cause the one or more data processors to perform various operations, such as receiving data indicative of a user interaction associated with a product or service. Several feedback instruments may be received based on the received data. Each of the several feedback instruments may have one or more rules and a limiting criterion associated with the feedback instrument. A determination may be made whether the one or more rules are satisfied for each feedback instrument. For each feedback instrument that the one or more rules are satisfied, a determination may be made whether the limiting criterion has not been met. For each feedback instrument that the one or more rules are satisfied and the limiting criterion has not been met, an indication may be provided that the user is a candidate for that feedback instrument. A selection of a feedback instrument may be made from the set of one or more feedback instruments that the user is indicated as a candidate, and the selected feedback instrument may be provided to the user.

In still another implementation, a method for providing real-time feedback statistics may include receiving data indicative of a user interaction associated with a product or service and several feedback instruments. The several feedback instruments may each be associated with one or more rules and a limiting criterion. For each of the several feedback instruments, a determination may be made whether the one or more rules are satisfied. A determination may also be made whether the limiting criterion has not been met for each feedback instrument. An indication may be made that the user is a candidate for each feedback instrument in which the one or more rules are satisfied and the limiting criterion has not been met. A selection of a feedback instrument may be made from a set of one or more feedback instruments for which the user is indicated as a candidate. The selected feedback instrument may be provided to a user. A response to the selected feedback instrument may be received and stored in a database. A customer satisfaction score may be determined based on the received response, and display data to effect display of the customer score may be provided.

### BRIEF DESCRIPTION OF THE DRAWINGS

Various embodiments taught herein are illustrated by way of example, and not by way of limitation, in the figures of the accompanying drawings, in which:

FIG. 1 is an overview of an example system of a feedback instrument management system;

FIG. 2 is a block diagram of an example feedback instrument of the feedback instrument management system of FIG. 1;

FIG. 3 is a flow diagram of an example method for providing a feedback instrument in response to a user interaction using the feedback instrument management system of FIG. 1;

FIG. 4 is a flow diagram of an example method for generating a report associated with a service based on one or more feedback responses that may be received using the feedback instrument management system of FIG. 1;

FIG. 5 is an illustration of an example interface that may be used with the feedback instrument management system of FIG. 1;

FIG. 6 is an illustration of an example new feedback instrument creation panel for the interface of FIG. 5; and

FIG. 7 is a block diagram illustrating a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and embodiments of, methods, apparatuses, and systems for providing information on a computer network. The various concepts introduced above and discussed in greater detail below may be implemented in any of numerous ways, as the described concepts are not limited to any particular manner of implementation. Examples of specific embodiments and applications are provided primarily for illustrative purposes.

According to some embodiments, it may be useful to enable a business or other entity to accurately identify, record, and report on customer satisfaction using a single system. In particular, it may be useful to identify a specific feedback instrument, such as a survey, to send to a specific customer or user for a given user interaction such that the information received in response to the feedback instrument may be the most relevant based on the user interaction. Furthermore, it may be useful to provide a system that may determine if other feedback instruments and/or other communications with a user or customer have been sent to avoid inundating the user or customer with surveys or other material. The system may provide valuable information for product and/or service enhancements to retain current users or customers and/or may attract new business based on customer satisfaction or development of useful customer-friendly products and/or services.

An example system may include the ability to manage a number of feedback instruments and/or rules for feedback instruments for identifying users to which the feedback instruments should be sent. In addition, an example system may be used to build or customize feedback instruments, including selecting specific questions, and may manage the different feedback instruments of the system. The system may also manage broader limiting criteria, such as the number of feedback instruments sent over a time period and/or the number of communications sent to a user. The system may further include an interface, such as a survey dashboard, that may enable user-friendly feedback instrument generation, measurement and analysis, reporting, and/or other features. Such an interface may allow an individual using the system to approve and publish feedback instruments to be sent to customers or users. Such a system may provide a consolidated platform for the management of multiple rule-driven feedback instruments, the selection of feedback instruments based on predefined rules, and/or real-time feedback instrument reports with overall customer satisfaction scores based on the responses to the feedback instruments.

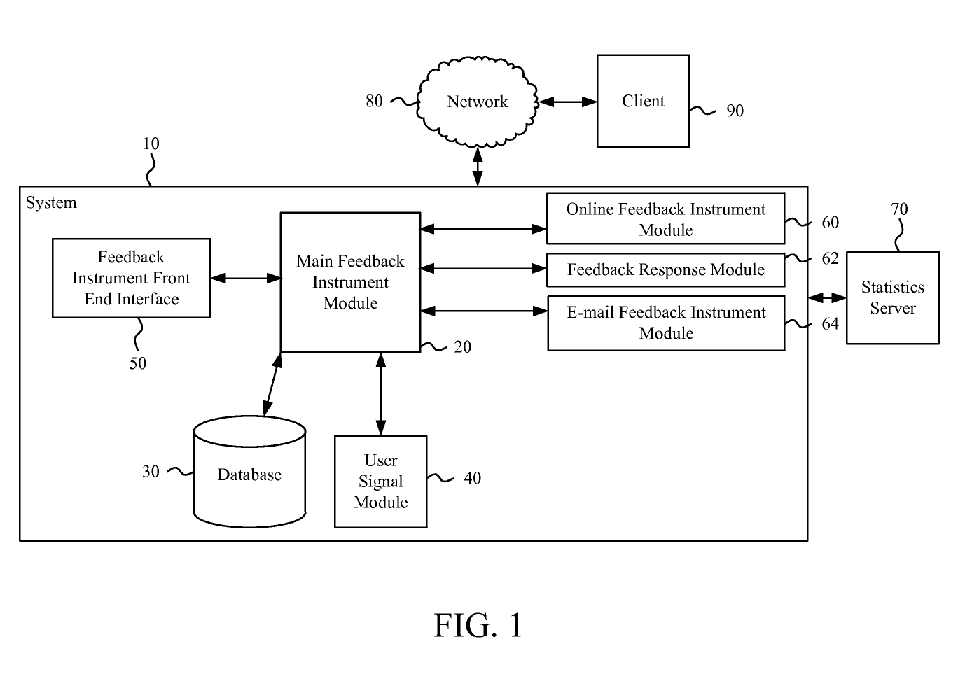

FIG. 1 depicts an overview of an example feedback instrument management system 10 having a main feedback instrument module 20, a database 30, a user signal module 40, a feedback instrument front end interface 50, an online feedback instrument module 60, a feedback response module 62, and/or an e-mail feedback instrument module 64. In the present example, system 10 may be connected to a network 80 that may be connected to one or more clients 90. The network 80 can include computer networks such as the Internet, local, wide, metro or other area networks, intranets, and/or other computer networks such as voice or data mobile phone communication networks. The client 90 may include a computing device such as a computer, laptop, desktop, smart phone, tablet, personal digital assistant, or server device configured to communicate with other devices via the network 80. The client 90 can execute a software application (e.g., a web browser, e-mail application, and/or other applications) from a tangible medium (e.g., a memory device) to receive content from other computing devices or systems, such as system 10, over the network 80. The client 90 of the present example may be a device to which a feedback instrument of the feedback instrument management system 10 may be sent.

In the present example, the main feedback instrument module 20 may include one or more application programming interfaces (“APIs”) on a computing device or processing module such that the main feedback instrument module 20 may manage and/or interact with the other modules and/or components of the feedback instrument management system 10, as will be described in greater detail herein. In some implementations, the main feedback instrument module 20 may be hosted on a computing device that may be separate from the other modules or components of the feedback instrument management system 10 or the main feedback instrument module 20 may be local to the other modules or components.

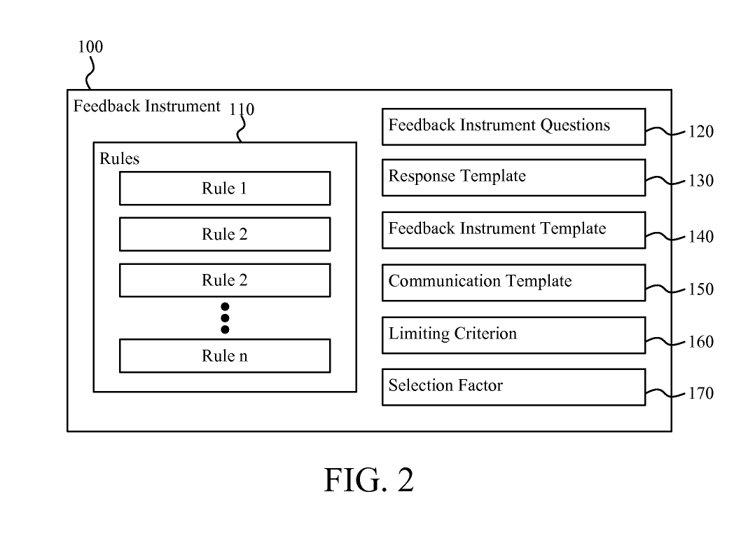

The database 30 may be configured to store information for retrieval, use, and/or storage for main feedback instrument module 20. For example, the database 30 may store multiple feedback instruments (e.g., surveys or other feedback eliciting instruments), feedback instrument templates, feedback responses, rules, feedback instrument questions, communication templates, response templates, reporting data, limiting criteria, and/or other data. An example block diagram of an example feedback instrument, such as a survey, that may be stored in the database 30 is shown in FIG. 2. The database 30 may include a hard disk drive, a flash drive, a tape drive, RAM, ROM, and/or any other computer-readable storage medium or a computing device having a computer readable storage medium. The database 30 may be local to the main feedback instrument module 20 or may be remote from the main feedback instrument module 20 (e.g., on another computing device). In some implementations, portions of the database 30 may be local and some may be remote. Other configurations for database 30 may be implemented as well.

The main feedback instrument module 20 may be in communication with a user signal module 40. The user signal module 40 may be configured to receive user interactions concerning or otherwise associated with a product or service and/or other user interactions. For example, the user signal module 40 may be configured to determine which resources, such as help files and/or web pages, a user or customer accesses while the user is logged into a service; to determine whether a user requested support services and/or received support solutions; to determine one or more prior customer satisfaction feedback results for a user or customer; to determine whether a user has requested follow up support; to determine a user spending total; to determine a change in a user spending total; to determine a user product volume; to determine a change in user product volume; to determine a pattern change for a user; to determine an inactivity of a user; to determine one or more feedback instruments or other communications previously sent to a user; and/or other user interactions. In some implementations, a user may decline to have any or all of the foregoing information determined by the user signal module 40.

For situations in which the systems discussed here collect personal information about users, or may make use of personal information, the users may be provided with an opportunity to control whether programs or features that may collect personal information (e.g., information about a user's activities, a user's preferences, or a user's current location). In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the user signal module 40.

In some implementations, the user signal module 40 may include one or more APIs. Further still, the user signal module 40 may be local to the main feedback instrument module 20, remote from the main feedback instrument module 20 (e.g., on another computing device), and/or portions of the user signal module 40 may be remote and other portions may be local. In one example system, the user signal module 40 may be configured to retrieve user signal data from other resources (e.g., from other computing devices, from a client 90, and/or otherwise). Other implementations of the user signal module 40 may be used as well.

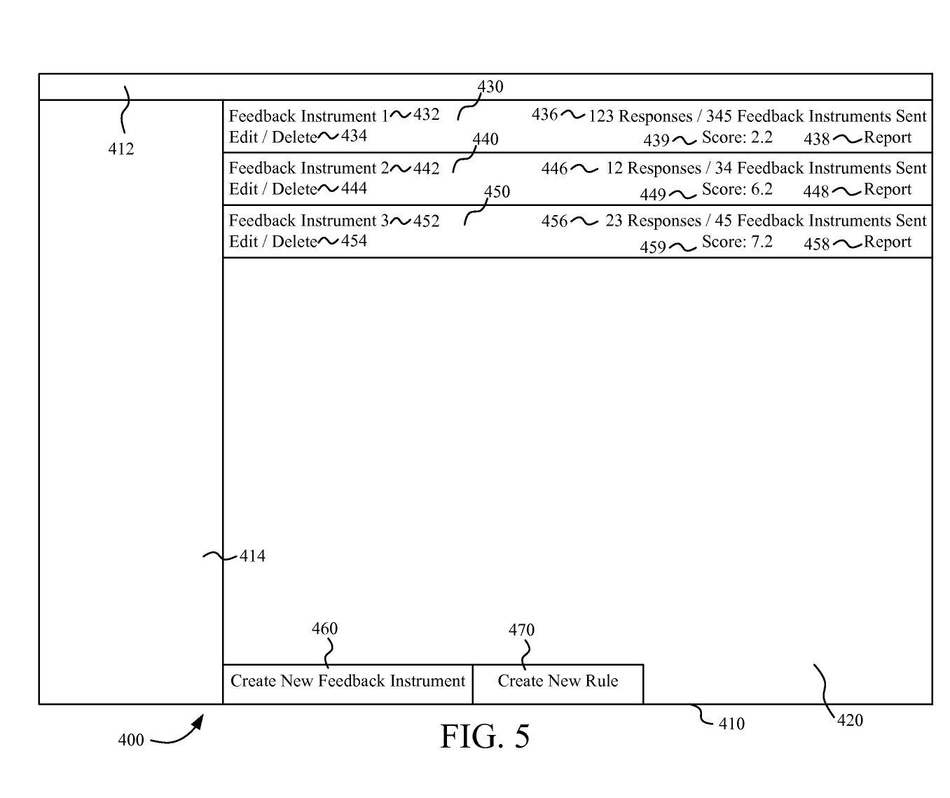

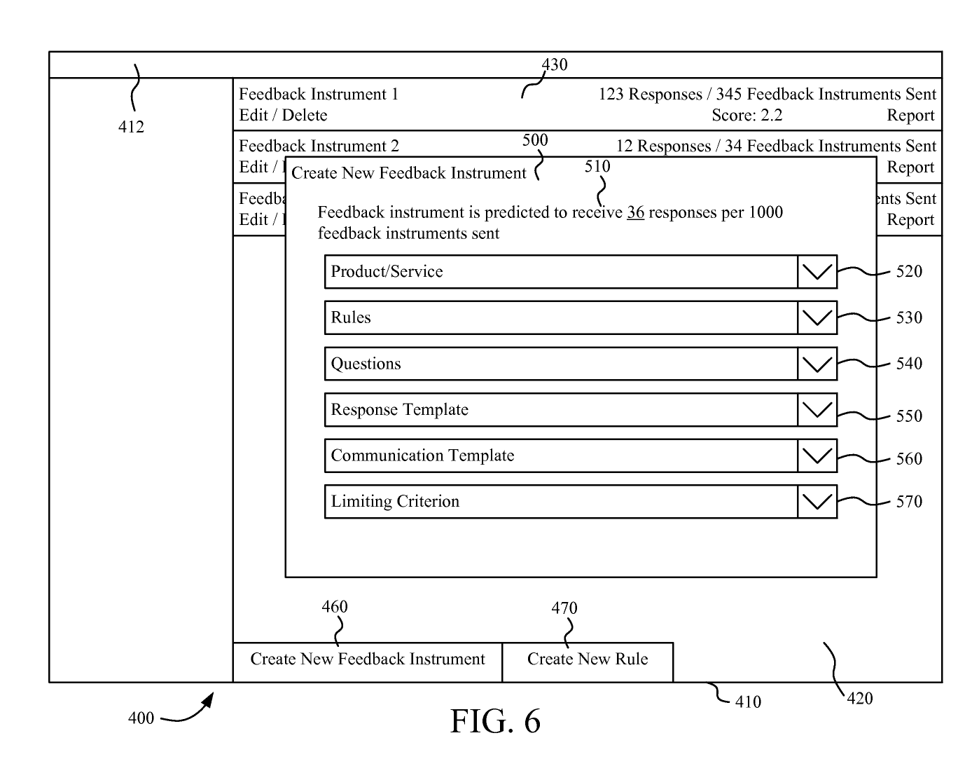

The main feedback instrument module 20 may access and/or otherwise interact with the feedback instrument front end interface 50 such that data from the main feedback instrument module 20 may be displayed on a display device, such as a liquid crystal display, active matrix display, or the like. An example of such a feedback instrument front end interface is shown and described in reference to FIGS. 5 and 6.

The main feedback instrument module 20 may also be in communication with one or more other modules. For example, an online feedback instrument module 60 may be configured to publish a feedback instrument from main feedback instrument module 20 online (e.g., generating a survey web page or the like). A feedback response module 62 may be configured to generate a feedback instrument response object based on a feedback instrument response template for a feedback instrument such that a respondent may respond to one or more feedback instrument questions of the feedback instrument. An e-mail feedback instrument module 64 may be configured to generate an e-mail feedback instrument and/or to send the e-mail feedback instrument to one or more users. A feedback instrument retrieval module (not shown) may be configured to retrieve and/or generate a feedback instrument based on one or more of the user signals described above. A feedback instrument campaign module (not shown) may be configured to retrieve information regarding one or more feedback instrument campaigns for a product or service for use in generating a feedback instrument and/or otherwise. Still other modules may be implemented in the feedback instrument management system 10. One or more of the foregoing modules may include one or more APIs on a computing device or other processing module and/or one or more of the foregoing modules may be local to the main feedback instrument module 20 or remote from the main feedback instrument module 20 (e.g., on another computing device). In some implementations, the features of any or all of the foregoing modules may be integrated into main feedback instrument module 20 such that a single module may be provided.

In some implementations, one or more of the foregoing modules or components of feedback instrument management system 10 may transmit data to and/or request data from a statistics server 70 to retrieve data representative of statistics associated with a feedback instrument or multiple feedback instruments, such as response statistics (positive responses, negative responses, total responses, etc), e-mail statistics (e-mails sent, e-mail responses, etc.), and/or other statistics. In some implementations, statistics server 70 may be local to feedback instrument management system 10 or may be remote from feedback instrument management system 10 (e.g., on another computing device).

While the foregoing generally describes an example feedback instrument management system 10, other configurations for the feedback instrument management system 10 may be implemented as well. In addition, one or more of the foregoing modules and/or components may be omitted or modified for feedback instrument management system 10.

FIG. 2 depicts an example block diagram of a feedback instrument 100, such as a survey in the present example, that may be specified and/or created by an individual using system 10 and utilized with system 10. The feedback instrument 100 may include a set of rules 110, one or more feedback instrument questions 120, a feedback instrument template 130, a response template 140, a communication template 150, a limiting criterion 160, and a selection factor 170. The feedback instrument 100 may be specified and/or created by an individual interacting with the front end feedback instrument interface 50 of the feedback instrument management system 10. For example, utilizing the front end feedback instrument interface 50, an individual may determine the set of rules 110 for the feedback instrument 100 such that the individual can specify which users or customers may be selected as candidates to receive the feedback instrument 100. The rules may include rules relating to user interactions, such as customer spending (e.g., an advertising customer's spending exceeds a threshold, falls below a threshold, is within a certain range, etc.); volume change for a customer (e.g., an advertising customer's number of ads is above a threshold, below a threshold, is within a certain range, etc.); pattern change of a customer (e.g., an advertising customer is no longer using a certain feature, no longer using text ads, etc.); frequency of activity of a customer (e.g., an advertiser has been inactive for a month, three months, a year, an advertiser has no active advertising campaigns, the advertiser has low or no ad impressions served, etc.); FAQ page rank; and/or otherwise. In some implementations, the rules may specify a certain product or service that may be associated with the feedback instrument 100. For example, a feedback instrument 100 may include a rule such that the feedback instrument 100 may be sent only to users or customers who have interacted with a help center service. Still other rules may be utilized to specify the users or customers to whom the feedback instrument 100 is to be sent (e.g., training services, sales services, specific products, etc.).

One or more of the foregoing rules or sets of rules may be stored in the database 30 such that the rules may be selected when generating the feedback instrument 100 without having to recreate the rule or set of rules. For instance, a rule specifying that a user or customer has been inactive for over six months may be stored in the database 30 such that the rule may be associated and used with other feedback instruments 100. In some implementations, a new rule may be created and/or defined for a feedback instrument 100 using one or more features of the feedback instrument front end interface 50. For example, a pop-up window may include fields to specify the type of rule, the values that would satisfy the rule, etc., as will be described below. The rule may be saved to the database 30 for subsequent use with other feedback instruments.

Multiple feedback instrument questions 120 may be associated with the feedback instrument 100. Similar to the set of rules 110, the feedback instrument questions 120 may be stored in the database 30 such that one or more of the questions 120 may be selected for use with other feedback instruments 100. Thus, the creation of a feedback instrument 100 using the feedback instrument management system 10 may use one or more stored feedback instrument questions 120 and/or a stored set of questions for a new feedback instrument 100. New questions may also be generated for the feedback instrument 100 during the creation of the feedback instrument 100.

A feedback instrument template 130 may also be associated with a feedback instrument 100. In some implementations, the feedback instrument template 130 may include HTML, XML, Javascript, and/or other coding to effect display of the feedback instrument 100 as a web page and/or as part of an e-mail. The feedback instrument template 130 may include textual instructions for the feedback instrument 100, a visual layout for the feedback instrument 100, formatting for the feedback instrument 100, and/or the like. A response template 140 may also be associated with the feedback instrument 100. The response template 140 may similarly include HTML, XML, Javascript, and/or other coding to effect display of a response portion to the feedback instrument 100 for a web page and/or as part of a response e-mail. The response template 140 may include radio buttons for rating scales (e.g., radio buttons corresponding to each individual numeral for the ranges 0 to 5, 1 to 5, 0 to 10, 1 to 10, etc.), text boxes, and/or the like for a user or customer to provide responses to the feedback instrument questions 120. A communication template 150 may be associated with the feedback instrument 100 as well. The communication template 150 may include text, images, or other information for an e-mail or other communication to be sent to the user or customer when the feedback instrument 100 is sent.

A limiting criterion or criteria 160 may be associated with the feedback instrument 100. For example, a feedback instrument may be limited to a temporal limiting criterion (e.g., a survey is limited to 20 surveys per hour, 20 surveys per week, the survey is active for a 6 month period, only send 20 surveys per hour for a certain language, etc.). Other limiting criteria 160 may be used as well, such as a total number of feedback instruments sent (e.g., a maximum of 10,000 sent feedback instruments), a total number of responses (e.g., only send the feedback instrument if the total number of responses are below 1,000), whether the user or customer has received another feedback instrument (e.g., do not send a user or customer a feedback instrument if they have received another feedback instrument in the preceding 7 days), and/or other limiting criteria may be implemented. Multiple limiting criteria 160 may also be associated with the feedback instrument 100.

A selection factor 170 may also be associated with the feedback instrument 100. For example, the selection factor may include a priority value (e.g., 0.0 to 1.0, 0 to 100, 0 to 10, 0 to 5, etc.) such that feedback instruments 100 with a higher priority value may be selected over feedback instruments with lower priority values (or vice versa), as will be described in greater detail below. In some other implementations, the selection factor 170 may include an auction factor. The auction factor may be based on a customer satisfaction score associated with the feedback instrument 100 (e.g., a survey having the lowest average customer satisfaction score may be selected, a survey having the highest average customer satisfaction score may be selected, a survey having the lowest customer satisfaction scores for the past ten surveys may be selected, etc.); a customer satisfaction score associated with a product or service (e.g., a survey for a product or service having the lowest average customer satisfaction score may be selected, a survey for a product or service having the highest average customer satisfaction score may be selected, a survey for a product or service having the lowest customer satisfaction scores for the past ten surveys may be selected, etc.); a monetary value, and/or the like.

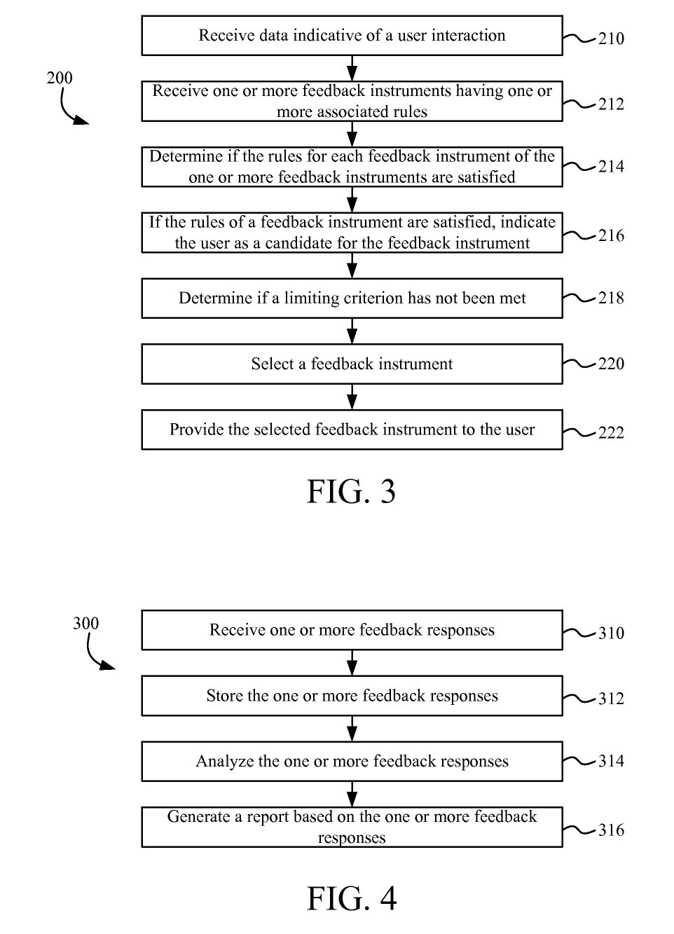

FIG. 3 depicts an example method 200 of providing a user or customer with a feedback instrument, such as the feedback instrument 100 of FIG. 2, using the feedback instrument management system 10 of FIG. 1. The method 200 may be initiated in response to the system 10 receiving data indicative of a user interaction (block 210). For example, user signal module 40 of feedback instrument management system 10 may receive one or more user interactions concerning or associated with a product or service and/or otherwise receive user interactions. Examples of such user interactions may include accessing a resource, such as a help file and/or web page, requesting support services and/or receiving support solutions, prior customer satisfaction results, a request for follow up support, a spending total, a change in spending total, a product volume, a change in product volume, a pattern change for a user, an inactivity period, previously receiving one or more feedback instruments or other communications, and/or other signals. In some implementations, multiple signals may be received and utilized. The data indicative of the user interaction may be associated with a product or service. For example, a user interaction of accessing a specific help file may be associated with a help center service such that the system 10 may utilize the information in selecting a feedback instrument to send to the user or customer. Examples of products or services may include a help center service, a training service, a sales service, new client services, advertising products, and/or the like.

One or more feedback instruments may be received having one or more associated rules (block 212). For example, in the system 10 shown in FIG. 1, the main feedback instrument module 20 may receive one or more feedback instruments, such as surveys or other questionnaires, from the database 30 and/or the main feedback instrument module 20 may send a request to another module, such as a feedback instrument retrieval module or feedback instrument campaign module, to receive one or more feedback instruments associated with a feedback instrument campaign or otherwise. In some implementations, the received feedback instruments may be limited by one or more additional rules of the system 10. For example, the received feedback instruments may be limited to only the active feedback instruments, e.g., surveys that may still be sent for the current time period, such as a 1 hour rolling time period. Other additional rules for limiting which feedback instruments may be received may be implemented as well.

The received feedback instruments may each include one or more rules. For each of the one or more received feedback instruments, a determination may be made as to whether the one or more rules associated with each feedback instrument are satisfied (block 214). For example, the main feedback instrument module 20 may receive a feedback instrument from the database 30 having an associated set of rules that indicate the feedback instrument is to be sent to a user or customer only if the user or customer uses the help center service and has accessed a help page on billing. If one or more of the rules for the feedback instrument are not met, then the user or customer may not be indicated as a candidate for the feedback instrument. If all of the rules are met for a feedback instrument, then the user may be indicated as a candidate for the feedback instrument (block 216). Thus, it should be understood that the feedback instruments may be specifically directed to users or customers based on the set of rules associated with each feedback instrument and based on the interactions received. Accordingly, the system 10 may be able to automatically send a relevant feedback instrument to a user or customer based on the user or customer interaction and the rules associated with the feedback instrument. The foregoing steps, blocks 214 and 216, may be repeated for each feedback instrument of the one or more feedback instruments received at block 212 and a user or customer may be indicated as a candidate for multiple feedback instruments.

A determination may be made of whether a limiting criterion has not been met for each feedback instrument that the user is indicated as a candidate (block 218). For example, a feedback instrument may be limited to a temporal limiting criterion (e.g., a survey is limited to 20 surveys per hour, 20 surveys per week, only send the survey for a 6 month period, only send 20 surveys per hour for a certain language, etc.). Other limiting criteria may be used as well, such as a total number of sent feedback instruments (e.g., only send 10,000 feedback instruments), whether the user or customer has received another feedback instrument (e.g., do not send a user or customer a feedback instrument if they have received one in the preceding 7 days), and/or other limiting criteria may be implemented. The main feedback instrument module 20 of system 10 may determine whether the limiting criterion for each feedback instrument that the user or customer is indicated as a candidate has not been met. For example, a user or customer may be indicated as a candidate for three feedback instruments based on the received user interaction and the rules of the feedback instruments. If one of the feedback instruments has reached a maximum number of feedback instruments to be sent for the current hour (e.g., the feedback instrument's limiting criterion has been met), then that feedback instrument may be ineligible for selection. Accordingly the user or customer may no longer be indicated as a candidate for that feedback instrument and/or the user or customer may be indicated as a candidate for only the other two feedback instruments.

A selection of a feedback instrument may be made from the one or more feedback instruments that a user or customer is indicated as a candidate and the limiting criterion has not been met (block 220). If a user or customer is indicated as a candidate for a single feedback instrument and the limiting criterion has not been met, then the single feedback instrument may be selected. If the user or customer is indicated as a candidate for more than one feedback instrument and the limiting criterion has not been met for the feedback instruments, then a selection may be made from the multiple feedback instruments, such as by the main feedback instrument module 20. In one implementation, the selection may be a random or pseudo-random selection of a feedback instrument from the set of multiple feedback instruments.

In some implementations, the selection may be made based, at least in part, on a priority value. Each feedback instrument may be associated with a priority value (e.g., 0.0 to 1.0, 0 to 100, 0 to 10, 0 to 5, etc.) such that feedback instruments with a higher priority value may be selected over feedback instruments with lower priority values when a user or customer is indicated as a candidate for more than one feedback instrument and the limiting criterion has not been met for the multiple feedback instruments. For example, a first feedback instrument having an associated priority value of 0.7 may be selected over a second feedback instrument having an associated priority value of 0.3. Thus, individuals creating feedback instruments for the system 10 may prioritize the feedback instruments using a priority value for the feedback instrument.

In another implementation, the selection of a feedback instrument from the multiple feedback instruments may be selected based, at least in part, on one or more received auction factors that may be associated with a feedback instrument. For example, each feedback instrument of the set of feedback instruments may have one or more associated auction factors. In some implementations, the auction factor may be based on a customer satisfaction score associated with a feedback instrument (e.g., a survey having the lowest average customer satisfaction score may be selected, a survey having the highest average customer satisfaction score may be selected, a survey having the lowest customer satisfaction scores for the past ten surveys may be selected, etc.); a customer satisfaction score associated with a product or service (e.g., a survey for a product or service having the lowest average customer satisfaction score may be selected, a survey for a product or service having the highest average customer satisfaction score may be selected, a survey for a product or service having the lowest customer satisfaction scores for the past ten surveys may be selected, etc.); a monetary value, and/or the like. Still other bases for the auction factors and/or other selections of a feedback instrument from the multiple feedback instruments may be implemented. An auction may be performed using the auction factors to select a feedback instrument from the multiple feedback instruments.

The selected feedback instrument may be provided to the user or customer (block 222). For example, the system 10 may generate a communication, such as by using communication template 150 of an example feedback instrument 100, to send the selected feedback instrument to the user or customer. For example, the feedback instrument may be sent as an attachment to an e-mail, as a link within the e-mail, within the e-mail, and/or otherwise.

FIG. 4 depicts an example method 300 for receiving and analyzing feedback responses. It should be understood that method 300 may be combined with any part or all of method 200 described above or method 300 may be independent of method 200. In the present example, one or more feedback responses may be received (block 310). For example, one or more feedback responses may be received in response to providing a selected feedback instrument to a user or customer (block 222 of FIG. 3). The one or more feedback responses may be stored, such as in the database 30, (block 312). An analysis may be performed on the one or more feedback responses (block 314). For example, the one or more feedback responses may be analyzed to determine a trend in customer satisfaction scores for a feedback instrument, an overall customer satisfaction score for the feedback instrument, a determination of low scoring questions, a determination of high scoring questions, and/or the like. In some implementations, an analysis may be made for all the feedback instruments associated with a product or service. In some implementations, the statistics from the analysis may be stored on statistics server 70. A report may be generated based on the one or more feedback responses (block 316). For example, a report may be generated for a specific service or product such that an overall view of the service or product may be obtained. Still other analyses and/or reports may be implemented as well.

FIG. 5 depicts an example feedback instrument front end interface 400 that may be used with the system 10 shown in FIG. 1. The interface 400 includes a main panel 410 having a navigation bar 412, a left panel 414, and a central panel 420. The navigation bar 412 may include navigation links (not shown) to other pages and/or may include other features. The central panel 420 may include a table of one or more feedback instruments for feedback instrument management system 10 that may have been created by an individual accessing feedback instrument front end interface 400 and/or who may be permitted to view and/or modify the feedback instruments. In the example shown, three example feedback instruments 430, 440, 450 are shown in central panel 420.

The feedback instruments 430, 440, 450 include a title 432, 442, 452; one or more modification features 434, 444, 454; an informational portion 436, 446, 456; a report feature 438, 448, 458, and an indicator 439, 449, 459. The titles 432, 442, 452 may include automatically generated titles (e.g., based on an associated product, a random number, a sequential number, etc.) or the title 432, 442, 452 may be user-defined when the feedback instrument 430, 440, 450 is created.

The modification features 434, 444, 454 of the present example include an edit feature and a delete feature. Selection of edit feature may open a pop-up window that may be utilized to modify one or more aspects of the feedback instrument 430, 440, 450. The pop-up window for the modification of the feedback instruments 430, 440, 450 may be similar to the pop-up 500, as will be described below in reference to FIG. 6. Selection of the delete feature may delete the feedback instrument 430, 440, 450 from the database 30 and/or may simply deactivate the feedback instrument 430, 440, 450 such that the feedback instrument 430, 440, 450 remains in the database 30, but may no longer active.

The informational portion 436, 446, 456 may include information regarding the status of the feedback instrument 430, 440, 450. In the example shown, the informational portion 436, 446, 456 includes statistics for each feedback instrument 430, 440, 450 about how many responses have been received and feedback instruments sent. Other information, such as an associated service or product, a real-time customer satisfaction score, and/or the like may be provided in the information portion 436, 446, 456.

Selection of a report feature 438, 448, 458 may generate a report and/or provide other statistics or analytics for the corresponding feedback instrument 430, 440, 450. For example, selection of a report feature 438, 448, 458 may generate a report such as that described in reference to method 300. Indicators 439, 449, 459 may display a customer satisfaction score or other data associated with the corresponding feedback instrument 430, 440, 450. In some implementations, the indicators 439, 449, 459 may be updated in real time as responses to the feedback instruments 430, 440, 450 are received. Of course indicators 439, 449, 459 may be updated according hourly, daily, weekly, monthly, yearly, on demand, etc.

The central panel 420 may also include a feedback instrument creation button 460 and a rule creation button 470. FIG. 6 depicts an example pop-up display 500 that may be shown when the feedback instrument creation button 460 is selected. In the present example, the pop-up 500 includes a preview feature 510 and several selection fields 520, 530, 540, 550, 560, 570. The preview feature 510 may include a predicted response rate based on the data of the selection fields 520, 530, 540, 550, 560, 570 and historical and/or other predictive data, such as statistical information stored on statistics server 70 for previous feedback instruments having the same or similar data for one or more of the selection fields 520, 530, 540, 550, 560, 570. For example, one or more prior feedback instruments having one or more corresponding responses may be analyzed to provide a statistical model and/or weighting factors for estimating the number of responses based on the data values for the selection fields 520, 530, 540, 560, 570. Thus, the preview feature 510 may be used to predict a number of responses (e.g., for use in maximizing a number of responses and/or otherwise) and/or to provide other information when creating a feedback instrument.

The selection fields 520, 530, 540, 550, 560, 570 of the present example include a product or service field 520, a rules field 530, a questions field 540, a response template field 550, a communication template field 560, and a limiting criterion field 570. The product or service field 520 may include a menu that may be used to indicate one or more products or services with which the feedback instrument may be associated. In some instances, the product or service field may be omitted and/or included as part of the rules field 530.

The rules field 530 may include a menu that may be used to indicate one or more pre-defined rules and/or sets of rules with which the feedback instrument may be associated and/or a new rule may be defined using the rules field 530. Creation of a new rule may include a pop-up (not shown) in which the user may define the parameters of the rule (e.g., which products or services may be associated with the feedback instrument, which user interactions may be associated with the feedback instrument, etc.). The new rule creation may also be initiated by selection of the rule creation button 470 of the central panel 420.

The questions field 540 may include a menu that may be used to indicate one or more pre-defined questions and/or sets of questions with which the feedback instrument may be associated. The response template field 550 may also include a menu that may be used to indicate a response template (e.g., for defining the response type, scale, etc.) with which the feedback instrument may be associated. The communication template field 560 may also include a menu that may be used to indicate a communication template (e.g., a form e-mail or the like) with which the feedback instrument may be associated. The limiting criterion field 570 may also include a menu that may be used to indicate one or more limiting criteria, such as those described in reference to the limiting criterion 160, with which the feedback instrument may be associated and which may limit when the feedback instrument may be sent to users or customers. It should be understood that other fields may be implemented and/or other configurations for the pop-up 500 may be used.

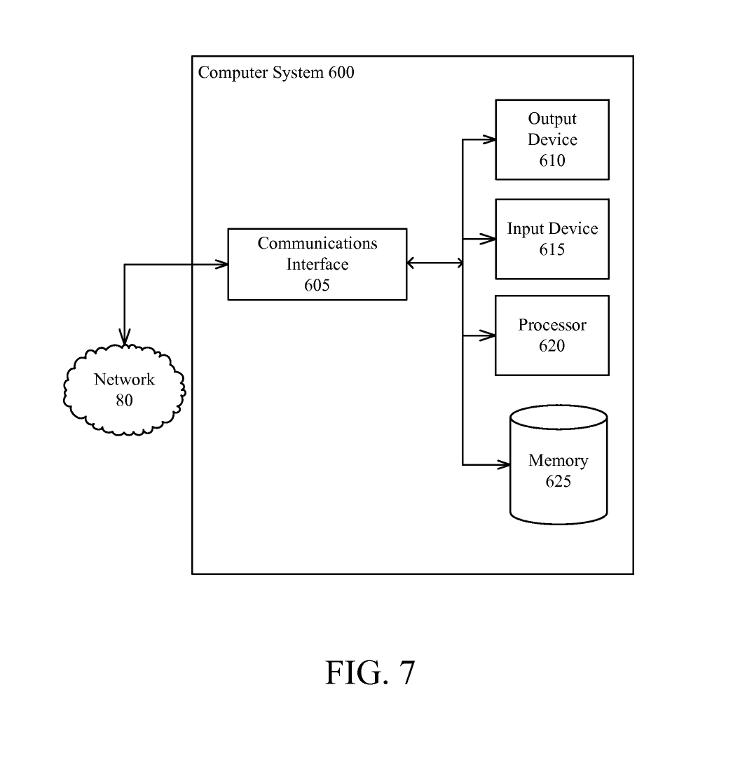

FIG. 7 shows the general architecture of an illustrative computer system 600 that may be employed to implement any of the methods or systems discussed herein (including the system 10 and its components, such as the main feedback instrument module 20) in accordance with some embodiments. In some implementations, multiple computer systems 600 may be used for one or more aspects of system 10 described herein. The computer system 600 may be used to provide information via the network 80. The computer system 600 comprises one or more processors 620 communicatively coupled to memory 625, one or more communications interfaces 605, one or more output devices 610 (e.g., one or more display units), and one or more input devices 615. The processors 620 may be included as part of the main feedback instrument module 20 or the other components of the feedback instrument management system 10.

In the computer system 600, the memory 625 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 10 of FIG. 1, the main feedback instrument module 20 may include the memory 625 to store the feedback instruments, feedback responses, feedback instrument templates, response templates, rules, data indicative of user interactions, communication templates, and/or other data. The processor(s) 620 may be used to execute instructions stored in the memory 625 and, in so doing, also may read from or write to the memory various information processed and or generated pursuant to execution of the instructions.

The processor 620 of the computer system 600 also may be communicatively coupled to or control the communications interface(s) 605 to transmit or receive various information pursuant to execution of instructions. For example, the communications interface(s) 605 may be coupled to a wired or wireless network, bus, or other communication means and may therefore allow the computer system 600 to transmit information to and/or receive information from other devices (e.g., other computer systems).

The output devices 610 of the computer system 600 may be provided, for example, to allow various information to be viewed or otherwise perceived in connection with execution of the instructions. The input device(s) 615 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The term “data processing apparatus,” “data processing system,” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product embodied on a tangible medium or packaged into multiple such software products.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including several of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

1. A computer-implemented method for sending a feedback instrument to a computing device in a computer network environment, the method comprising:
receiving, at one or more processing modules, data indicative of a plurality of client computing device interactions associated with a plurality of feedback instruments, a first of the plurality of client computing device interactions associated with a first service or product and a second of the plurality of client computing device interactions associated with a second service or product;
receiving, at the one or more processing modules, the plurality of feedback instruments, each feedback instrument of the plurality of feedback instruments having one or more rules and a limiting criterion associated with the feedback instrument;
determining, by the one or more processing modules, that the client computing device satisfies the one or more rules associated with each feedback instrument of the plurality of feedback instruments based on the data indicative of the plurality of client computing device interactions;
indicating, that the client computing device is a candidate client computing device for each feedback instrument based on the determination that the client computing device satisfies the one or more rules associated with each feedback instrument;
determining, by the one or more processing modules, that the candidate client computing device does not meet the limiting criterion associated with each feedback instrument;
selecting, by one or more processing modules, a feedback instrument from the plurality of feedback instruments; and
providing, by the one or more processing modules, the selected feedback instrument to the client computing device.

2. The computer-implemented method of claim 1, wherein each feedback instrument of the plurality of feedback instruments is associated with a priority value, wherein the step of selecting a feedback instrument comprises selecting the feedback instrument based, at least in part, on the priority value.

3. The computer-implemented method of claim 1, wherein the step of selecting a feedback instrument comprises:
receiving a plurality of auction factors, wherein each auction factor of the plurality of auction factors is associated with a feedback instrument of the one or more feedback instruments for which the client computing device is indicated as a candidate and the associated limiting criterion has not been met; and
selecting a feedback instrument based, at least in part, on the plurality of received auction factors.

4. The computer-implemented method of claim 3, wherein each of the auction factors of the plurality of received auction factors comprises a satisfaction score.

5. The computer-implemented method of claim 1, wherein the limiting criterion is temporal.

6. The computer-implemented method of claim 1, wherein the limiting criterion comprises a number of feedback instruments over a predetermined time period.

7. The computer-implemented method of claim 1 further comprising:
receiving, at one or more processing modules, a response to the selected feedback instrument provided to the client computing device; and
storing, in a database, the response to the selected feedback instrument.

8. The computer-implemented method of claim 7 further comprising generating a report based, at least in part, on the response to the selected feedback instrument, wherein the report is associated with the first service or product.

9. The computer-implemented method of claim 8, wherein the first service or product comprises a help center service.

10. The computer-implemented method of claim 8, wherein the first service or product comprises a training service.

11. The computer-implemented method of claim 8, wherein the first service or product comprises a sales service.

12. A system for managing feedback instruments for one or more products or services, the system comprising:
one or more data processors; and
one or more computer readable storage devices storing instructions that, when executed by the one or more data processors, cause the one or more data processors to perform operations comprising:
receiving data indicative of a plurality of client computing device [[user]] interactions associated with a plurality of feedback instruments, wherein a first of the plurality of client computing device interactions is associated with a first service or product, and a second of the plurality of client computing device interactions is associated with a second service or product,
receiving the plurality of feedback instruments each feedback instrument of the plurality of feedback instruments having one or more rules and a limiting criterion associated with the feedback instrument,
determining, that the client computing device satisfies the one or more rules associated with each feedback instrument of the plurality of feedback instruments based on the data indicative of the plurality of client computing device interactions,
determining that the candidate client computing device does not meet the limiting criterion associated with each feedback instrument,
indicating, for each feedback instrument for which the one or more rules associated with the feedback instrument are satisfied and the limiting criterion associated with the feedback instrument has not been met, that the user is a candidate for the feedback instrument,
selecting a feedback instrument from the plurality of feedback instruments, and
providing the selected feedback instrument to the client computing device.

13. The system of claim 12, wherein each feedback instrument of the plurality of feedback instruments is associated with a priority value, wherein the operation of selecting a feedback instrument from the set of one or more feedback instruments comprises selecting the feedback instrument based, at least in part, on the priority value.

14. The system of claim 12, wherein the operation of selecting a feedback instrument from the set of one or more feedback instruments comprises:
receiving one or more auction factors, wherein each auction factor of the one or more auction factors is associated with a feedback instrument from the set of one or more feedback instruments for which the client computing device is indicated as a candidate, and
selecting a feedback instrument based, at least in part, on the one or more received auction factors.

15. The system of claim 14, wherein the one or more auction factors comprises an average satisfaction score of the feedback instrument.

16. The system of claim 14, wherein the one or more auction factors comprises a satisfaction score of a product or service with which the feedback instrument is associated.

17. The system of claim 12, wherein the limiting criterion comprises whether the client computing device has received a previous feedback instrument within a predetermined time period.

18. The system of claim 12, wherein the limiting criterion comprises a total number of feedback instruments sent.

19. A method for providing real-time feedback statistics for a product or service offered in a computer network environment, the method comprising:
receiving, at one or more processing modules, data indicative of a plurality of client computing device interactions associated with a plurality of feedback instruments, wherein:
a first of the plurality of client computing device interactions is associated with a first service or product
a second of the plurality of client computing device interactions is associated with a second service or product, and
each feedback instrument of the plurality of feedback instruments has one or more rules and a limiting criterion associated with the feedback instrument;
determining, by the one or more processing modules, that the client computing device satisfies the one or more rules associated with each feedback instrument of the plurality of feedback instruments based on the data indicative of the plurality of client computing device interactions;
determining, by the one or more processing modules, that the candidate client computing device does not meet the limiting criterion associated with each feedback instrument of the plurality of feedback instruments;
indicating that the client computing device is a candidate for a set of feedback instruments of the plurality of feedback instruments if each of the one or more rules associated with each feedback instrument of the set of feedback instruments are satisfied and the limiting criterion associated with each of the set of feedback instruments has not been met;
selecting, by the one or more processing modules, a feedback instrument from the set of feedback instruments for which the user is indicated as a candidate;
providing, by the one or more processing modules, the selected feedback instrument to the client computing device;
receiving, at the one or more processing modules, a response to the selected feedback instrument;
storing, in a database, the response to the selected feedback instrument;
determining, by the one or more processing modules, a customer satisfaction score for the selected feedback instrument based, at least in part, on the received response; and
providing, by the one or more processing modules, display data to effect display of the determined customer satisfaction score.

20. The method of claim 19, wherein the display data to effect display of the determined customer satisfaction score is displayed by an indicator associated with the selected feedback instrument.
